(19) United States
(12) Patent Application Publication
(10) Pub. No.: US 2010/0125358 A1
(43) Pub. Date: May 20, 2010

(54) Method and System for Generating Shift Reports Without Data Redundancies

(75) Inventors: Armin Friemelt, Offenburg (DE); Cedric Reinartz, Dannstadt-Schauernheim (DE)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(73) Assignee: SAP AG, Walldorf (DE)

(21) Appl. No.: 12/275,105

(22) Filed: Nov. 20, 2008

(51) Int. Cl. G06F 19/00

(52) U.S. Cl. 700/111

(57) ABSTRACT

The embodiments of the present invention provide a shift report module that improves the accuracy of the information within the shift report by flagging or avoiding redundant entries between shift reports and ensuring that entries are not lost between shift reports based on the time that they were entered and the time that the shift reports were generated.

### BACKGROUND

1. Field of the Invention

The invention relates to a shift report generation system. Specifically, the embodiments of the invention relate to a shift reporting system that tracks and corrects late production confirmation data.

2. Background

Shift reports are utilized by shift supervisors to monitor the production of the workers during a particular shift. Unfortunately, employees often do not record their production information in a production tracking system before a shift ends or before a shift report is generated. For example, machine shop operators on a shop floor do not always have time to record their production into a production tracking system prior to the end of their shift. These production information entries, referred to as production confirmation entries, are often created after the end of the shift. This creates problems for supervisors seeking to review worker productivity for a shift.

The shift supervisor generates a shift report at the end of the shift, which is prior to the entry of these late production confirmation entries into the production tracking system. The shift report will not reflect the production of each of the individual workers on the shift, because this information is not yet available. Further complications in the analysis of productivity occur when later shift reports are generated. These later shift reports incorporate the late filed production confirmation entries and count them towards a following shift. Other issues can include the double inclusion of production confirmation entries in multiple shift reports, because the production confirmation entries indicate that the production occurred in an earlier shift, but the production confirmation entries themselves were not entered into the production tracking system until a later shift. If shift reports for a shift period during which production was completed and a subsequent shift period during which the production confirmation was entered are run at a time after the production confirmation entry is received, then both shift reports may include the production confirmation entries thereby skewing the production analysis in the shift reports. This makes it difficult for shift supervisors to accurately identify and review the productivity of the workers on their shift and can improperly affect the reviews of workers and shift supervisors by misplacing the actual production and productivity of workers into later shifts, thereby giving undue credit to later shifts.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a block diagram of one embodiment of a shift report generation system.

FIG. 2 is a diagram of an example set of production confirmation entries over the timeline of a set of shifts.

FIG. 3 is a flowchart of one embodiment of a process for generating a shift report using a simple listing.

FIG. 4 is a flowchart of one embodiment of a process for generating a shift report with a listing that avoids redundant listing of confirmations.

### DETAILED DESCRIPTION

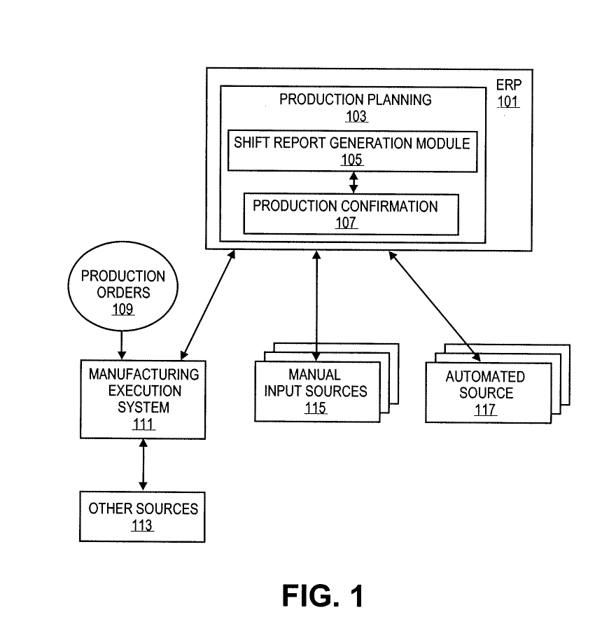

FIG. 1 is a diagram of one embodiment of a shift report generation system. In one embodiment, the shift report generation system can be incorporated into an enterprise resource planning (ERP) system 101 and/or a production planning system 103. In another embodiment, a shift report generation module 105 is a stand-alone module or a module that is incorporated into other types of software applications. These and other components together create a production tracking system for tracking worker production and for creating shift reports to review worker production.

The shift report module 105 interacts with a production confirmation module 107. The production confirmation module 107 gathers production confirmation entries or similar data structures from a set of input sources, such as manufacturing execution systems 111, manual input sources 115, automated sources 117, and similar production confirmation sources. A ‘set,’ as used herein, refers to any positive whole number of items including one item. Production confirmation entries are data structures that store product production information such as the time that production completes (i.e. the time that a worker completes the last product for the shift, referred to herein as the ‘production endpoint’), the time that execution completes (i.e., the time that a worker completes all activities for a shift, referred to herein as the ‘execution endpoint’), the confirmation completion time (i.e., the time that a worker enters the production information into the production tracking system, referred to herein as the ‘creation point’), numbers of products produced, types of products produced and similar information. The products that are tracked can be any type of manufactured products, produced documents, or similar work product.

The shift report generation module 105, as well as, the production planning module 103 and ERP system 101 can be executed by a computer system, such as a desktop computer system, laptop computer system, server or similar computing device. In another embodiment, the execution of these systems and modules is distributed over a set of computing devices. Production confirmation entries can be stored in a database that is connected to the production planning system 103 or ERP system 101. The production confirmation database can be provided by a database management system that is executed by the same computing device that executes the shift report generation module 105 or other components of the product tracking system.

In one embodiment, production confirmation entries can be received from an automated source 117. Automated sources 117 can include computing devices or simple sensor devices that monitor the condition of production machines, other computing devices, and similar resources to monitor the progress of a worker in the production of a product without the worker having to specifically input information about the progress of the production of the product. The automation of production confirmation entry generation can be partial or whole. Any field or aspect of production confirmation entries can be provided by a single sensor or automated source or a set of sensors or similar automated sources.

Production confirmation entries can also come from manual input sources 115. Manual input sources 115 can be computer devices, worksheets, punch cards or other forms of data collection that are filled out or utilized by a worker to record product production. If these manual input sources 115 are forms or worksheets or similar sources, then they can be entered into the product tracking system to be provided to the production confirmation module 107 by manual data entry, scanning or similar processes.

In one embodiment, production confirmation entries come from a manufacturing execution system 111. Manufacturing execution systems 111 are the production tracking systems of other entities, such as other warehouses, production facilities, or similar locations. These manufacturing cites may receive production orders 109 that they then complete. These manufacturing cites then provide these products to the local site where the shift report generation module 105 is being utilized or the location associated with the shift report generation module 105. The production input from these manufacturing execution system 111 sources can be incorporated into shift reports. For example, using production information received from manufacturing execution system 111 sources may allow the supervisor to compare the amount of incoming product to the output of the workers on his shift. Manufacturing executing systems 111 may also incorporate other production information sources 113 further up the chain of production in a supply chain or from similar sources.

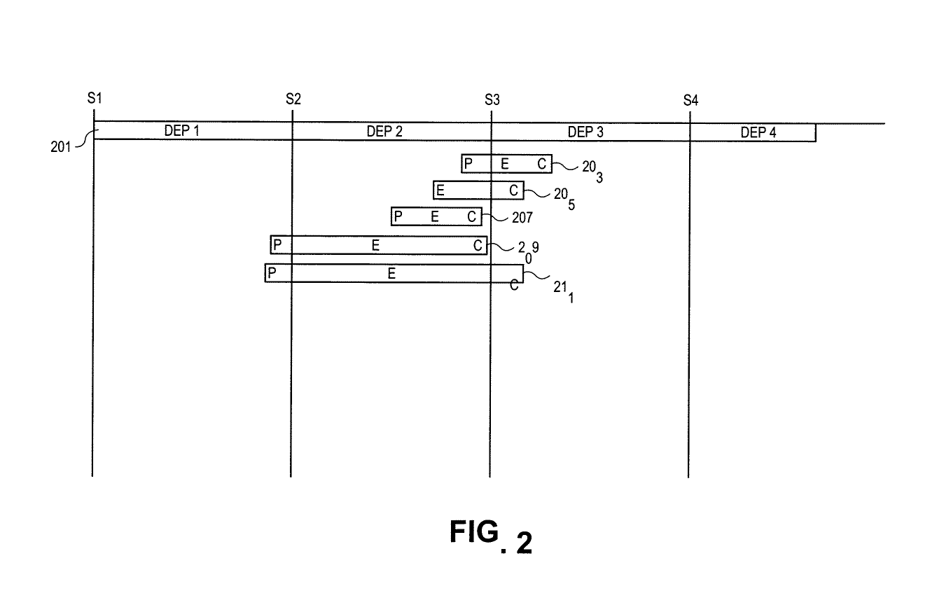

FIG. 2 is a diagram of one embodiment of a timeline of a shift schedule with a set of production confirmation entries that have been entered over a set of shifts. The shifts are delineated with a shift number appearing at the beginning of the shift. Specifically, shift one is S1, shift two is S2, shift three is S3, and shift four is S4. Each shift defines a data entry period (DEP) 201. Shift one has a data entry period DEP1, while shifts two, three, and four have data entry periods DEP2, DEP3, and DEP4, respectively. The data entry periods are the periods during which a production confirmation entry can be received and counted into the shift such that it will be ensured of being included in the shift report. The correspondence of a production confirmation entry to a data entry period or a shift can be based on different data fields in the production confirmation entry. Production confirmation entries can include a processing finish date or time (i.e., the production endpoint), an execution finish date and time (i.e., the execution endpoint), and a production confirmation entry date and time (i.e., the creation point), amongst other data fields. These are represented in the diagrams by P, E and C, respectively.

The diagram of FIG. 2 shows an example set of production confirmation entries. The first production confirmation 203 defines a production endpoint (P) that occurs during data entry period DEP2, but an execution endpoint (E) and creation point (C) that occurred during data entry period DEP3. Thus, a shift report that is generated to include each production confirmation entry based on production endpoints falling within a data entry period of a selected shift would count this production confirmation entry 203 only in shift 2. However, a shift report generation module that pulled all production confirmation entries with any value (P, E or C) that occurred during a shift would generate a shift report for shift 2 and a shift report for shift 3 that would both include this production confirmation entry 203.

The next production confirmation entry 205 includes an execution endpoint (E) that occurs in shift 2, but the creation point (C) is entered in shift 3. In some instances, the production endpoint (P) is not entered. Production endpoint (P) denotes the time at which the actual production process in which a worker is engaged ends. In contrast, the execution endpoint (E) may include additional time that the worker spends on his job, but does not result in any additional production. For example, often machines need to be cleaned or otherwise maintained at the end of a production operation, prior to the next production operation beginning. This time is included in the time leading up to the execution endpoint, but during this time no additional production has been generated.

Production confirmation entry 207 falls entirely within shift 2. Production confirmation entry 209 is similar to that of production confirmation entry 203 in that the production endpoint (P) occurs in a proceeding shift, in this case shift 1, while the creation point (C) is actually within shift 2. The final example production confirmation entry 211 spans three shifts where the production endpoint (P) occurs during shift 1, execution endpoint (E) occurs during shift 2, and the creation point (C) is not entered until shift 3. These varying production confirmation entry timelines give a sense of the complexity of the task of generating accurate shift reports.

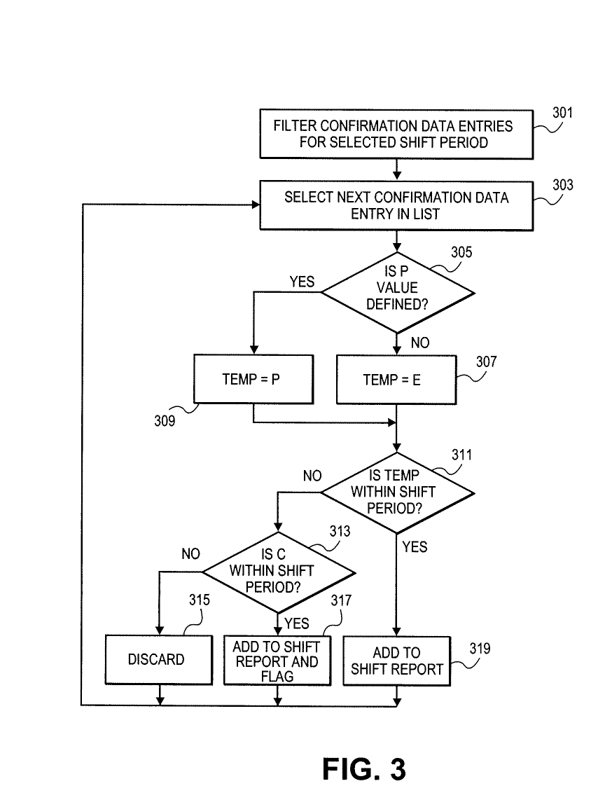

FIG. 3 is a flowchart of one embodiment of a process for generating a shift report using a simple listing. The process is initiated in response to a shift supervisor or similar user requesting that a shift report for a designated shift be generated using the shift report generation module. The shift report generation module filters the received or stored production confirmation data entries for those that fall within the selected shift period (block 301). The filtering can be based on any of the dates or fields of the production confirmation entry, including the production endpoint, execution endpoint, or the production confirmation entry creation point. The process then begins iterating through those production confirmation entries that remain after the filtering process has completed (block 303). The production confirmation entries are compiled into a list or similar data structure. A first entry in the list is selected for analysis. The process iterates through each production confirmation entry in the list.

The production endpoint is then checked for the currently selected entry (block 305). If the production endpoint is defined (e.g., it is not null or zero), then this date/time will be utilized for determining the proper shift report in which to place the corresponding production confirmation entry. If the production endpoint has been defined, then a temporary value is set equal to that production endpoint value (block 309). If the production endpoint value has not been defined, then the execution endpoint date/time will be utilized to place the production confirmation entry into the appropriate shift report. In this case the temporary value is set to be equal to the execution endpoint value.

The temporary value is compared to the shift period (block 311). If the temporary value falls within the shift period, then the currently selected production confirmation entry is added to the shift report for the selected shift period that is being generated (block 319). However, if the temporary value does not fall within the selected shift period, then a check is made to determine whether the production confirmation entry was completed (i.e., entered into the production tracking system) within the selected shift period (block 313). If the production confirmation entry was completed during the shift period, this would indicate that it was not part of a previous shift report or, if it was, it would be redundant to place it into both shift reports. Thus, the production confirmation entry is added to the shift report that is currently being generated, but the entry is flagged to indicate that it has been incorporated into a shift report. In subsequently generated shift reports, the flagging can help the reviewer to recognize that the data may be redundant or misplaced (block 317). If the production confirmation entry was not generated within the selected shift period, then this production confirmation entry is discarded for purposes of creating the current shift report (block 315).

After the decision regarding the addition of the production confirmation entry to the shift report has been completed (blocks 315, 317, and 319), then the next production confirmation entry in the list is selected for analysis. This process continues until all the production confirmation entries in the list generated after the filtering have been exhausted.

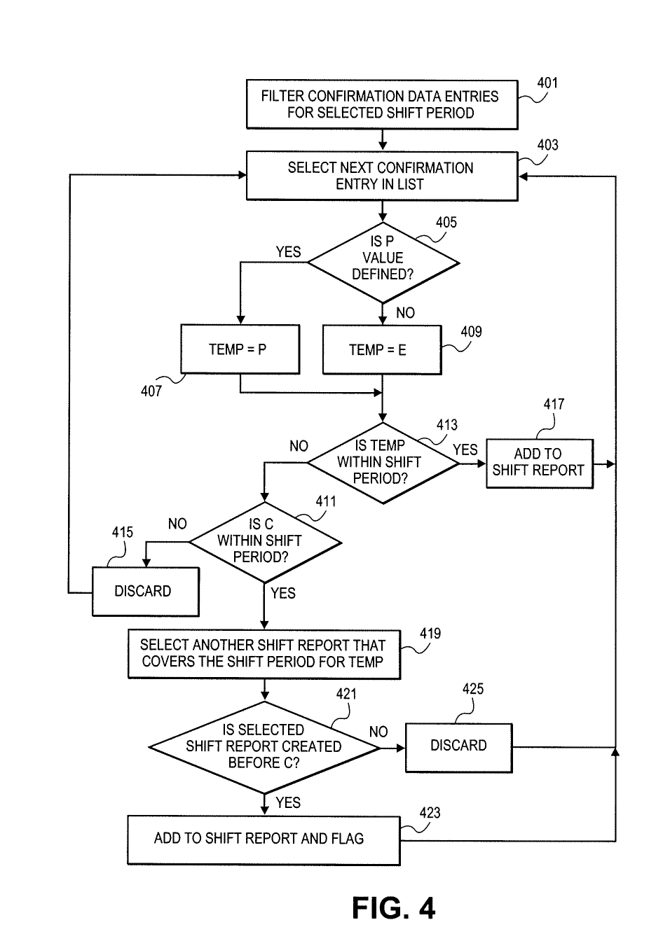

FIG. 4 is a flowchart of one embodiment of a process for generating a shift report using a listing that avoids redundant listing of confirmations. In one embodiment, the process is initiated in response to the user selecting a specific shift period for a shift report to be generated. The process then begins by filtering the production confirmation data entries to find those that are related to the shift report period that has been selected (block 401). The filtering may find all of the production confirmation data entries that have a production endpoint, execution endpoint or creation point that falls within the shift report.

The process continues by selecting a first production confirmation entry from the list of filtered entries (block 403). This production confirmation entry is analyzed to determine whether the production endpoint value has been defined (i.e., it is not a null or zero value) (block 405). The production endpoint value, if defined, is utilized for the sorting of the production confirmation entry into the proper shift report. If the production endpoint value has been defined, then a temporary value is set to that production endpoint value (block 407). However, if this production endpoint value has not been defined, then the temporary value that is utilized for sorting the production confirmation entry is the execution endpoint value (block 409). In this scenario, the execution endpoint date/time is utilized in place of the production endpoint date/time. The temporary value is set to the execution endpoint value in this scenario.

After the temporary value has been set, the temporary value is checked to see whether it falls within the selected shift period (block 413). If the temporary value is within the selected shift period, then the currently selected production confirmation entry is added to the shift report (block 417). The process then continues on to analyze the next production confirmation entry in the list (block 403).

If the temporary value does not fall within the shift period, then the creation point is checked to determine whether it falls within the shift period that is currently selected (block 411). If the creation point does not fall within the selected shift period, then this production confirmation entry is discarded (block 415). The process then continues on to analyze the next production confirmation entry in the list (block 403).

If the creation point does fall within the shift period, then the shift report that covers the shift period for the temporary value is determined (block 419). This would be a shift report period that proceeds the currently selected period either immediately or any number of shift periods earlier. A check is then made to determine whether the shift report for the period that is determined to correspond to the temporary value was created before the confirmation of the currently selected production confirmation entry (block 421). If the shift report that corresponds to the temporary value was created after the production confirmation entry date, then presumably the production confirmation entry is already a part of that shift report and nothing needs to be done with it at this time and it is discarded for purposes of generating the current shift report (block 425). The process then continues on to analyze the next production confirmation entry in the list (block 403). However, if the shift report had been created before the confirmation date, then the production confirmation entry is added to the current shift report and flagged to indicate that it does not properly belong in the current shift report, but that it had not been included in the proper shift report (block 423). This ensures that every production confirmation entry is placed into a report and guarantees that there are not redundancies in the shift reports that are not, at the very least, flagged to provide notice to the reviewer.

In one embodiment, the production tracking system including the shift report generation module may be implemented as hardware devices. In another embodiment, these components may be implemented in software (e.g., microcode, assembly language or higher level languages). These software implementations may be stored on a computer-readable medium. A “computer-readable” medium may include any medium that can store or transfer information. Examples of a computer-readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method of shift reporting comprising:
identifying a production confirmation data entry that falls within a designated shift period by an execution endpoint or a production endpoint; and
determining whether the production confirmation data entry has a creation point within the selected shift period in response to determining that the execution endpoint or production endpoint is not within the selected shift period.

2. The method of claim 1, further comprising:
determining whether the production confirmation data entry has been included in a previous shift report.

3. The method of claim 1, further comprising:
marking the production confirmation data entry in a shift report to indicate inclusion in another shift report.

4. The method of claim 1, further comprising:
adding the production confirmation entry to a shift report for the selected shift period in response to determining that the execution endpoint or production endpoint fell within the selected shift period.

5. The method of claim 1, further comprising:
adding the production confirmation data entry to the shift report in response to determining that the production confirmation data entry is not in a previous shift report and the creation point of a previous shift report precedes the creation point of the confirmation data entry.

6. The method of claim 1, further comprising:
identifying a shift report having a shift period covering a production endpoint or execution endpoint of the production confirmation data entry.

7. The method of claim 1, further comprising:
determining whether a production endpoint has been defined for the production confirmation data entry.

8. A system for shift report generation comprising:
a production confirmation module to receive production confirmation entries; and
a shift report generator coupled to the production confirmation module to create a shift report by listing each production confirmation entry that has a production endpoint or execution endpoint that falls within a corresponding shift period, the shift report generator to exclude a production confirmation entry from the shift report where a creation point and production endpoint or execution endpoint do not fall within the corresponding shift period.

9. The system of claim 8, wherein the production confirmation module generates production confirmation entries from received user input specifying a production endpoint, execution endpoint or creation point.

10. The system of claim 8, wherein the production confirmation module generates production confirmation entries from automated reporting sources that provide a production endpoint, execution endpoint or creation point.

11. The system of claim 8, wherein the production confirmation module generates production confirmation entries from data received from a manufacturing execution system.

12. A computer-readable medium having stored therein a set of instructions, which when executed, cause the computer to perform a set of operations comprising:
identifying a production confirmation data entry that falls within a designated shift period by an execution endpoint or a production endpoint; and
determining whether the production confirmation data entry has a creation point within the selected shift period in response to determining that the execution endpoint or production endpoint is not within the selected shift period.

13. The computer-readable medium of claim 12, having stored therein a further set of instructions, which when executed cause the computer to perform a further set of operations comprising:
determining whether the production confirmation data entry has been included in a previous shift report.

14. The computer-readable medium of claim 12, having stored therein a further set of instructions, which when executed cause the computer to perform a further set of operations comprising:
marking the production confirmation data entry in a shift report to indicate inclusion in another shift report.

15. The computer-readable medium of claim 12, having stored therein a further set of instructions, which when executed cause the computer to perform a further set of operations comprising:
receiving the production confirmation data entry from a production confirmation module.

16. The computer-readable medium of claim 12, having stored therein a further set of instructions, which when executed cause the computer to perform a further set of operations comprising:
adding a production confirmation data entry to the shift report in response to determining that the production confirmation data entry is not in a previous shift report and the creation point of a previous shift report precedes the creation point of the production confirmation data entry.

17. The computer-readable medium of claim 12, having stored therein a further set of instructions, which when executed cause the computer to perform a further set of operations comprising:
identifying a shift report having a shift period covering a production endpoint or execution endpoint of the production confirmation data entry.

18. The computer-readable medium of claim 12, having stored therein a further set of instructions, which when executed cause the computer to perform a further set of operations comprising:
determining whether a production endpoint has been defined for a production confirmation data entry.
